(19) United States
(12) Patent Application Publication
(10) Pub. No.: US 2021/0241288 A1
(43) Pub. Date: Aug. 5, 2021

(54) METHOD AND SYSTEM FOR DETERMINING RETURN OPTIONS FOR INVENTORY ITEMS

(71) Applicant: Target Brands, Inc., Minneapolis, MN (US)

(72) Inventors: Yogesh Hunsur Doreswamy, Bengaluru (IN); Velmurugan Kathiresan, Bengaluru (IN); Arun Kumar Padmanabhan, Bengaluru (IN); Cleo Pinto, Minneapolis, MN (US); Caitlin Sicora, Minneapolis, MN (US); Megan Tanck, Minneapolis, MN (US); Karthik Umamaheshwara, Bengaluru (IN); David Rickers, Minneapolis, MN (US)

(21) Appl. No.: 16/777,601

(22) Filed: Jan. 30, 2020

(51) Int. Cl. G06Q 30/00; G06Q 20/40

(52) U.S. Cl. CPC G06Q 30/016; G06Q 30/0185; G06Q 20/4016

(57) ABSTRACT

A method of determining a return option for a customer of a retail enterprise. The method includes receiving a request to return a previously-ordered inventory item. The request includes item attributes including an item description and an item cost of the previously-ordered inventory item. Customer attributes are received, which include a customer profile, historical sales order metrics, and historical return metrics from a customer attribute database. A risk score for the customer is determined. The risk score is based, at least in part, on the customer attributes and one or more rules assessed by a customer risk assessment tool of the retail enterprise. Based on the risk score and the item attributes, at least one return processing option for the customer is automatically determined. The at least one return processing option is presented to the customer for selection.

### TECHNICAL FIELD

The present disclosure relates generally to methods and systems for customer-initiated product returns. More particularly, the present disclosure describes a system architecture for determining a return option to a customer based on item attributes and customer attributes.

### BACKGROUND

Retail merchants often have return policies that attract customers. However, retail merchants must balance the customer's desired liberal return policy with loss of sales and the potential for abusive/fraudulent behavior. A return policy must consider the retailer's loss of sale, inability to resell the returned product, restocking costs, and fraudulent behavior of the customer.

Different types of return policies are often available to customers. For example, a customer may be given a refund, such as cash back for a return. Alternatively, a customer may be offered an exchange for a new product. Traditional return policies are based on retail merchant's rules, and do not factor into the customer or which product the customer is returning.

Although having a uniform return policy for all customers may be simple to administer, often such policies result in lower customer satisfaction. Still further, while one user's activity may be acceptable given that user's historical interactions with the retailer, another user exhibiting similar behavior may be more likely to be considered as attempting to conduct a fraudulent return transaction given that customer's history, or the type of item that is the subject of the return.

### SUMMARY

In summary, the present disclosure relates to methods and systems for allowing a customer to self-initiate a return of an item, and automatically receive a customized, appropriate return option based on the level of trust of the customer and the item to be returned. Various aspects are described in this disclosure, which include, but are not limited to, the following aspects.

In a first aspect, a method of determining a return option for a customer of a retail enterprise is disclosed. The method includes receiving, from a customer at a customer account page of a retail website, a request to return a previously-ordered inventory item, the request identifying the previously-ordered inventory item. The method further includes receiving customer attributes of a customer associated with an order including the previously-ordered inventory item, the customer attributes including a customer profile, historical sales order metrics, and historical return metrics from a customer attribute database. Then, a risk score is determined for the customer. The risk score is based at least in part on the customer attributes and one or more rules assessed by a customer risk assessment tool of the retail enterprise. Based on the risk score and item attributes, at least one return processing option is automatically determined. The return option is determined for the customer at a return processing service tool. The at least one return processing option is presented to the customer for selection within a return user interface of the retailer website.

Another aspect includes a system for determining a return option for a customer of a retail enterprise. The system includes a computing system including one or more enterprise computing devices. The computing system includes at least one processor and a memory subsystem that has at least one memory device. The memory subsystem is communicatively coupled to the at least one processor, and stores a customer attribute database and instructions. The instructions are executable to provide a custom the risk assessment tool and returns processing service tool. The instructions are executed by the at least one processor, and cause the computing system to receive, from a customer at a customer account page of a retail website, a request to return a previously-ordered inventory item, the request identifying the previously-ordered inventory item, and receive customer attributes of a customer associated with an order including the previously-ordered inventory item, the customer attributes including a customer profile, historical sales order metrics, and historical return metrics from a customer attribute database. A risk score is determined for the customer. The risk score is based at least in part on the customer attributes and one or more rules assessed by a customer risk assessment tool of the retail enterprise. Based on the risk score and item attributes, at least one return processing option is automatically determined. The return option is determined for the customer at a return to processing service tool. The at least one return processing option is presented to the customer for selection, and is provided to the customer within a return user interface of the retail website.

Yet another aspect includes a method of determining a return option for customer of a retail enterprise. The method includes submitting, from a first customer, a first customer log-in at a retail web site. The method includes submitting a first request, from the first customer at a customer account page of the retail website, the first request to return a first previously-ordered inventory item, the first request identifying a first previously-ordered inventory item, and submitting a second request from the first customer at a customer account page of the retail website, the second request to return a second previously-ordered inventory item, the second request identifying the second previously-ordered inventory item. Based on the first previously-ordered inventory item and customer attributes of the first customer including a customer profile, historical sales order metrics, and historical return metrics, the method includes receiving a first set of return processing options selected from among a collection of possible return options for the first previously-ordered inventory item. Based on the second previously-ordered inventory item and customer attributes of the first customer including a customer profile, historical sales order metrics, and historical return metrics, the method includes receiving a second set of return processing options selected from among a collection of possible return options for the second previously-ordered inventory item, wherein the second set of return processing options includes at least one different return processing option as compared to the first set of return processing options.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example environment for self-initiating a return.

FIG. 2 illustrates an example method of determining at least one return option after receiving a request.

FIG. 3 illustrates a schematic diagram of an example return processing service system.

FIG. 4 illustrates a schematic diagram of a customer attribute database.

FIG. 5 illustrates a schematic diagram of how a return option is provided to customer.

FIG. 6 is an example architecture for determining a customer risk score.

FIG. 7 illustrates an example method of gathering information to create a customer profile.

FIG. 8 is illustrates a customer assurance risk application for determining a risk scoring for guest assurance.

FIG. 9 illustrates a method of a customer's actions for requesting a return.

FIGS. 10a-10b illustrate example user interfaces for requesting a return.

FIG. 11 is an example block diagram of a computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Whenever appropriate, terms used in the singular also will include the plural and vice versa. The use of “a” herein means “one or more” unless stated otherwise or where the use of “one or more” is clearly inappropriate. The use of “or” means “and/or” unless stated otherwise. The use of “comprise,” “comprises,” “comprising,” “include,” “includes,” and “including” are interchangeable and not intended to be limiting. The term “such as” also is not intended to be limiting. For example, the term “including” shall mean “including, but not limited to.”

In general, the present disclosure relates to methods and systems for automatically determining a return option for a customer after receiving a return request from the customer. A self-service return request, or a return request, is a request by a customer to return a previously-purchased inventory item. The return request is processed online at a user account page of a retailer's website. The return option presented to a customer are dependent on customer attributes and the item to be returned. The system also considers past interactions and current customer context to provide a risk score that can be used during a return request. The risk score can be used to determine which return option or options may be presented to a customer.

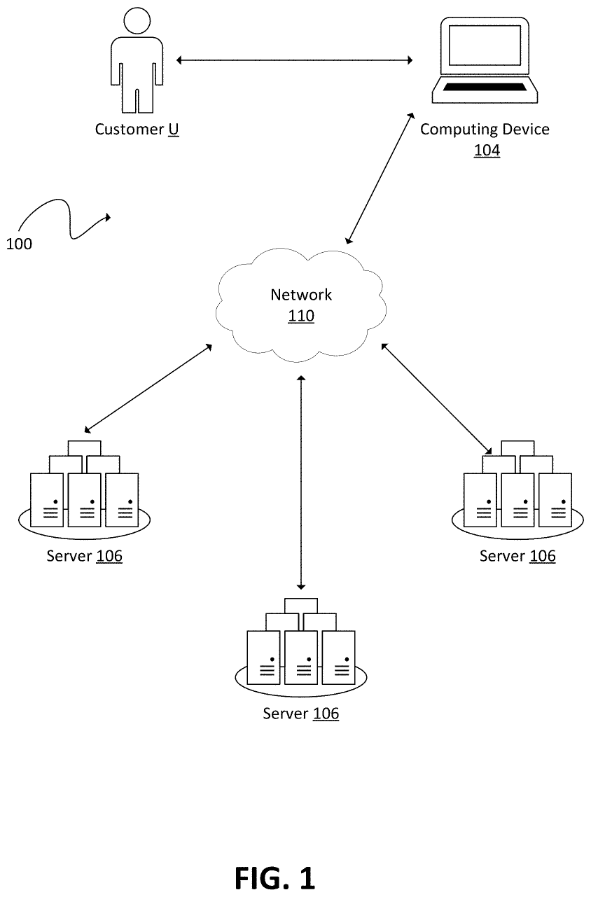

FIG. 1 illustrates an example environment 100 for processing a self-service return request from a customer. A customer U accesses computing device 104 to initiate a return request. The computing device 104 communicates with the network 110, which communicates with the plurality of servers 106. In various embodiments, the computing device 104 can be a computer (e.g., a laptop or desktop computer system) or a mobile device.

In use, a customer U logs into their account page on a retailer website (or within a retailer application of a mobile device) to request a return for a previously purchased inventory item. The computing device 104 communicates with the servers 106 over network 110 to determine which return option selected from among the collection of possible return options is available to the customer U. The server 106 provide a set of available return options to the customer U via the website or application for view/selection by the customer U.

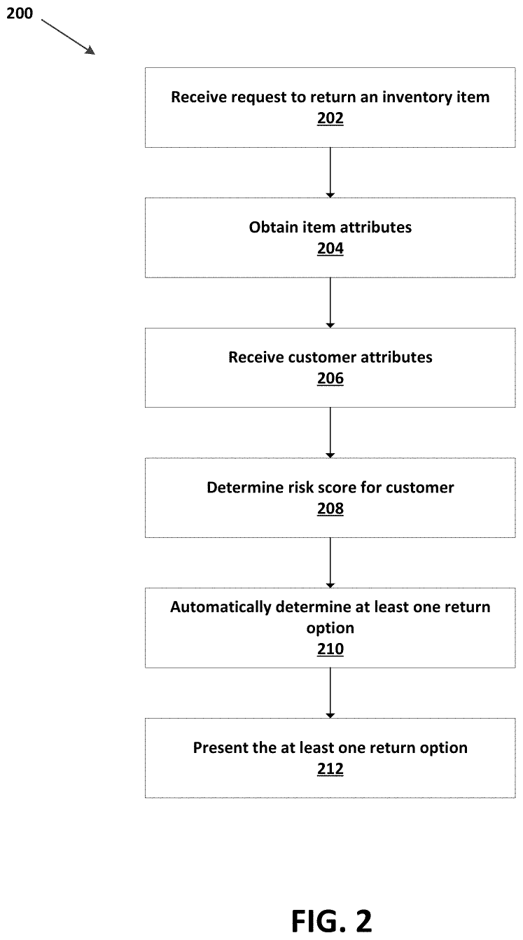

FIG. 2 illustrates an example method 200 of processing a return request. At step 202, a request to return an inventory item is received. The request may be received, at least in part, from a customer, for example after a customer has logged into their customer account page of a retailer website. In some instances, an indication initiating a request to return an inventory item is received from the customer, and specific details regarding the item or previous purchase may be received in response to subsequent requests to computing systems other than the customer's computing device.

At step 204, item and purchase attributes related to the previously purchased inventory item are obtained from the return request. Item and purchase attributes can, in some embodiments, include details about the item, as well as information about the previous purchase. For example, item attributes can include at least an item description, while purchase attributes can include, for example, cost paid for an item. The item description may include a SKU number, or other identifying characteristics of the inventory item, such as size or color. The item cost is the cost the customer paid for the inventory item at the time of purchasing. For example, the item cost may reflect any discounts or promotions the customer may have received.

In example embodiments, an indication of a request to return an item may be received at a retail website from a user device, and the retail website may relay that request, alongside item and purchase attributes, to a return processing service system, such as the example systems described herein.

At step 206, customer attributes are obtained by the return processing service system. Customer attributes include at least a customer profile, historical sales order metrics, and historical return metrics. The customer attributes may be received from a customer attribute database in response to a request for such customer attributes, which is described in more detail below. Customer attributes are automatically obtained based on the login information the customer used to access their customer account page of the retailer website; in alternative embodiments, an alternative identifying attribute of the customer may be used (e.g., credit card number, transaction identifier for a purchase, etc.).

At step 208 a risk score for a customer is determined. The risk score is based, at least in part on the customer attributes and one or more rules assessed by a customer risk assessment tool of the retail enterprise. The risk score is used in part to determine what types of return options may be presented to a specific customer for a specific inventory item. As described in further detail below, the risk score can be obtained, based at least in part, on historical transactions identifiable as involving the customer. For example, transactions involving the same credit card number, same user identifier, or having similar transaction patterns may be identified. The risk score may be higher for those customers having extensive transaction history and a determination of low risk of fraudulent activity, while a lower risk score may be determined for customers having only limited transaction history or some determination of past fraudulent activity, for example.

At step 210, at least one return option is automatically determined. The at least one return option is determined by the risk score and the item attributes. The return option is selected from among a plurality of return options. Example return options include a regular refund, an advance exchange, an issue refund now, and a customer can keep option. A regular refund is a refund provided only after receiving the item from the customer. The item may be received by return mail, or the customer may return the item in store. A regular exchange is an exchange order processed only after receiving the item from the customer. The item may be received by return mail, or the customer may return the item in store. An advance exchange is when the customer may or may not have already returned the item, but the exchange order is processed. For example, the replacement inventory item may be mailed or provided to the customer before the previously purchased inventory item has been received by the retail enterprise, but the customer is required to return the previously purchased inventory item. An issue refund now is providing a refund regardless of whether the inventory item has been returned. The customer can keep option is providing an exchange regardless of whether the inventory item has been returned. For example, the replacement inventory item may be mailed or provided to the customer even though the customer is not required to return the previously purchased inventory item.

In some cases, the at least one return option that is automatically determined corresponds to a selection of one or more return options. For example, the return option or selection of return options may be selected from among all possible return options, but an automatic determination may be made that certain return options are not to be made available to a particular customer. For example, although either a refund or exchange may typically be made available for customers having low risk of fraudulent activity, for a particular customer having a higher risk of fraudulent activity, that customer may only be presented with the exchange option.

At step 212 the at least one return option is presented to the customer. In an embodiment, only one return option is presented. In another embodiment, more than one return option is presented to the customer, and the customer is able to select which return option they desire. In some instances, fewer than all possible return options may be presented to a given customer (e.g., based on a value of the item to be returned, or an indication of possible past fraudulent activity by the customer).

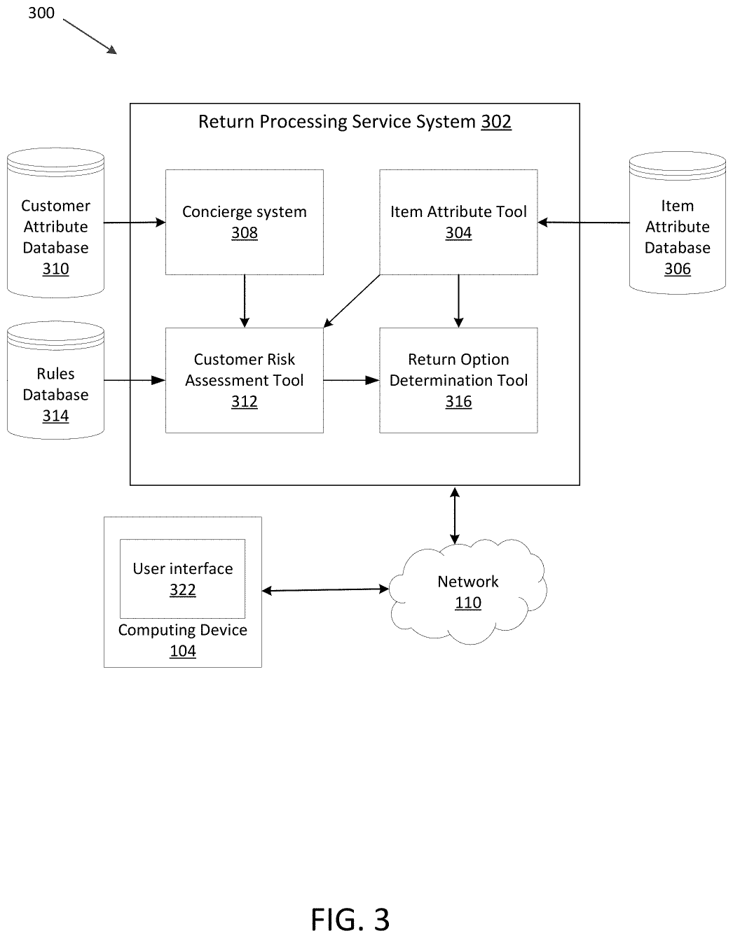

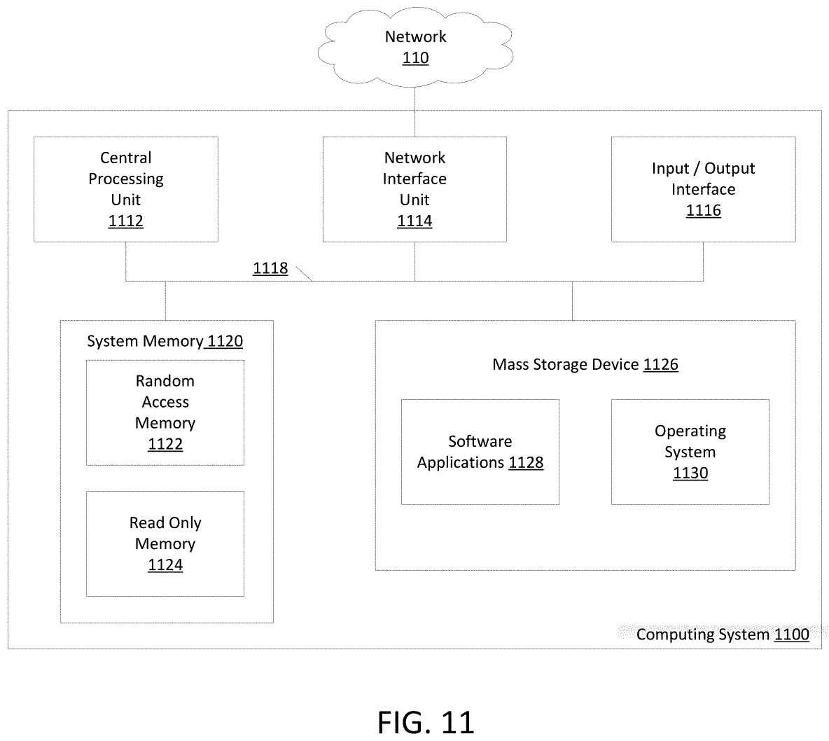

FIG. 3 illustrates an example architecture 300 for implementing a return processing service system 302. Return processing service system 302 can be implemented in the form of software tool executable on a computing device, such as the device shown in FIG. 11. An item attribute tool 304, a concierge system 308, a customer risk assessment tool 312, and a return option determination tool 316.

The return processing service system 302 receives a return request from the computing device 104 via the network 110. A return request is initiated by a customer who wants to return a previously-purchased inventory item. The customer submits the return request through a customer account page of a retail website. In response to receiving the return request, the return processing service system 302 requests inputs from a plurality of databases, such as a customer attribute database 310, an item attribute database 306, and a rules database 314.

Item attributes are received from an item attribute database 306, which is called by an item attribute API after receiving a request from the item attribute tool 304. The item attribute database 306 includes information such as item description and item cost. Other item attributes include size, color, or the item SKU.

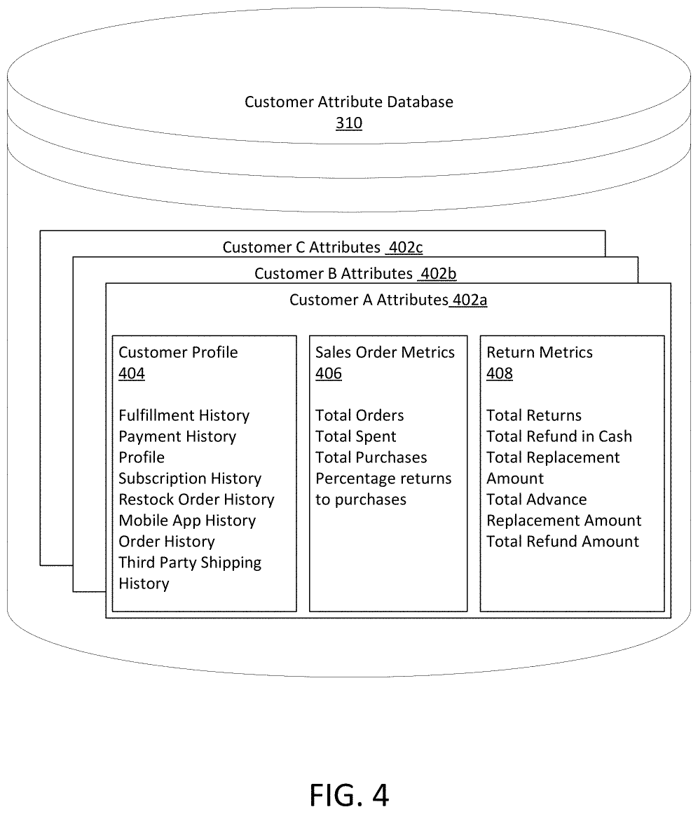

Customer attributes are received from a customer attribute database 310, which is accessed via a customer attribute API after the customer attribute API receives a request from a concierge system 308. The customer attribute database 310 stores information such as customer profile information, sales order metrics, and return metrics, which are described in more detail at FIG. 4 below.

Rules are received from a rules database 314, which is accessed via a rules API after a request is submitted to the rules API from a customer risk assessment tool 312. The rules database 314 stores information relating to rules and examples that are indicative of return abuse behavior. A first example rule may be that 20 return requests within the past year is indicative of fraudulent behavior. Another example rule may be that a predetermined number of purchases within a predetermined timeframe and subsequent return requests for the items at a higher price point is indicative of fraudulent behavior. Still further, a rule may be related to whether or not a customer is required to provide additional authentication information when using the customer account page of the retail website. Rules are used to determine which return options are presented to the customer.

In addition, rules may be related to the previously-purchased item, regardless of the customer attribute information. For example, an inventory item with a price above a threshold may be required to be returned before the refund or exchange occurs. In another example, an inventory item associated with a high frequency of fraudulent activity may be required to be returned before the refund or exchange occurs.

The inputs received from the concierge system 308 and the inputs received from the item attribute tool 304 are passed to the customer risk assessment tool 312. The customer risk assessment tool 312 uses the inputs to determine a customer risk score. The customer risk score is used to determine what return option or return options are available to the customer.

A risk score may be a numerical score, or other way of categorizing customers that helps determine how trustworthy a customer is. A customer risk score is used to determine which types of return options may be available to the customer. For example, a higher risk score may indicate that the customer is less trustworthy and represents more risk to the retail enterprise, while a lower risk score indicates the customer is more trustworthy and less of a risk to the retail enterprise. A customer with a lower risk score is less likely to be associated with fraudulent behavior.

In some embodiments, the customer risk score is generated in accordance with a normalized risk spectrum, and based on a model of previously observed customer activity (both fraudulent and non-fraudulent). In such cases, the model may be trained such that particular transactions, having been associated with potentially fraudulent activity, result in a higher risk score.

The return option determination tool 316 receives inputs from the item attribute tool 304 and the customer risk assessment tool 312. Based on the customer risk score and the item attributes, the return option determination tool 316 determines which at least one return option selected from among a plurality of return options are presented to the customer. A set of rules may be applied by the return option determination tool 316. For example, based on the customer risk score and optionally the value of the item to be returned, fewer than all possible return of options might be presented to the user e.g. to prevent users from obtaining a full refund for items prior to the retailer having the item in hand. Other possible rules to define available return options may be applied.

The user interface 322 can be viewed by the customer. In an example, the user interface 322 can provide a customer with access to view and select a presented return option from among the return options that are made available to the user.

The return processing service system 302 communicates with a computing device 104 through a network 110. The network 110 can be any of a variety of types of public or private communications networks such as the Internet. The computing device 104 can be any network—connected device including desktop computers, laptop computers, tablet computing devices, smart phones, and other devices capable of connecting to the Internet through wireless or wired connections.

FIG. 4 illustrates an example customer attribute database 310. The customer attribute database 310 includes customer attributes for a plurality of customers. Each customer attribute includes a customer profile 404, sales order metrics 406, and return metrics 408. The customer attributes are used to determine a customer risk score.

Example information included in a customer profile 404 includes fulfillment history, payment history, customer profile, subscription history, restock order history, mobile application history, order history, and third party shipping history. Fulfillment history includes information relating to orders that a customer placed and needed to fulfilled by the retail enterprise, payment history includes information relating to payments of previously-placed orders, customer profile information includes retailer credit card presence and usage, gift card presence and usage, retailer application presence, retailer loyalty card presence, and third party application presence. Retailer credit card activity includes information as to whether a customer has a retailer credit card and how often the credit card is used to make purchases. Gift card activity includes information as to whether customer has gift cards and how often the customer uses gift cards to make purchases.

Additionally, other information may be used to determine a customer attribute profile. Additional information may include subscription historical activity, restock order historical activity, registry historical activity, current open registry activity, and channel historical activity. Subscription historical activity includes what type of products the customer purchases through a subscription, how often they receive the product, and how long they have been receiving the product through the subscription. Restock order historical activity includes information relating to returns a customer placed, and whether or not the inventory item could be restocked. Registry historical activity includes whether or not the customer has created a registry for themselves, as well as how often the customer purchases items off of another customer's registry. Still further, registry historical activity includes how many items are on the customer's historical registry, as well as the dollar amount of each item on the registry. Current open registry activity includes information related to a current registry of the customer. For example, which items are on the registry list as well as the costs, in which items have been already purchased. Channel historical activity includes the types of transactions typically performed by the user, or any users, on a particular means of access to the retailer website (e.g., by browser, application, in-store, etc.).

Sales order metrics 406 include, at least, one or more of the following: total orders, total spent, total purchases, and percentage of returns to purchases. Total orders refers to the number of total order placed over a historical period of time. Total orders can include both in store purchases and online orders. An example period of time is the last six months, or the past year. Total spent is the total dollar amount spent in both in store purchases and online orders over a historical period of time. Total purchases includes the number of items purchases over a historical period of time. For example, if an order includes five different items, then the number of items purchased is five, even if the five items are the same item. The percentage of returns to purchases refers to the percentage of total purchases that were returned over a historical period of time.

Return metrics 408 include, at least one or more of the following: total returns, total refund in cash, total replacement amount, total advance replacement amount, and total refund amount.

Total returns refers to the number of returns requested and the number of returns granted over historical period of time. Total refund in cash refers to the total dollar amount that has been refunded to a customer over historical period of time. Total replacement amount refers to the dollar amount corresponding to items that have been replaced for a customer over historical period of time. Total advance replacement amount refers to the dollar amount corresponding to items that have been replaced for a customer before the item to be returned has been received over a historical period of time. The total refund amount refers to the dollar amount refunded to customer in cash and the dollar amount corresponding to items that has been replaced over historical period of time.

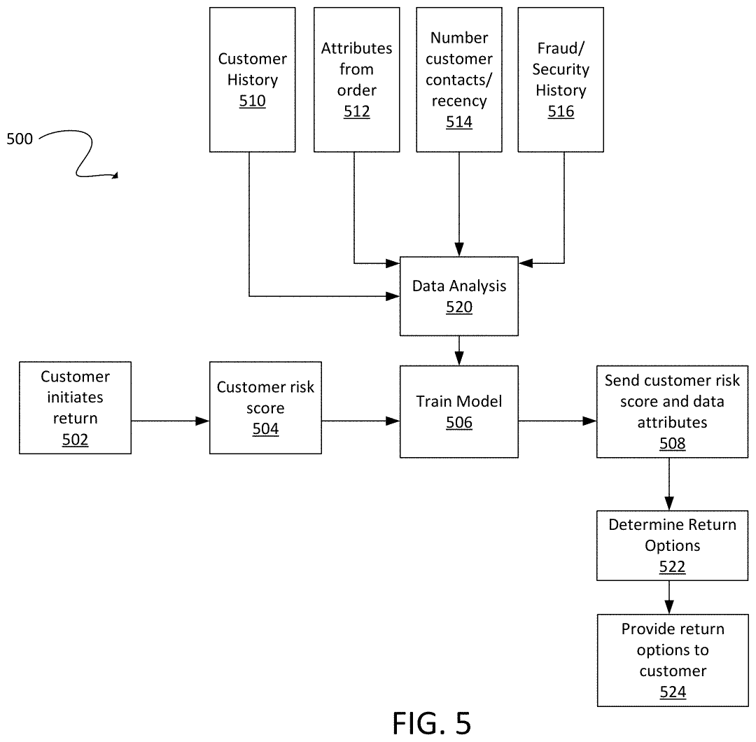

FIG. 5 illustrates an example dataflow 500 for detecting return abuse among customers and how to determine which type of return options are presented to the customer. The return abuse detection dataflow 500 is used to determine what type of return option may be provided to a customer, as the return options provided to a customer are dependent on whether or not the customer is a known return-abuser. The dataflow 500 may also be used to determine how trustworthy, loyal, or costly a customer is to the retail enterprise.

At step 502, a customer initiates a return request. As described above, the return request includes the item attributes including an item description and the item cost of the previously ordered inventory item. A return request may include more than one previously ordered inventory item. For example the return request may include a plurality of the same previously ordered items, or different previously ordered items.

At step 504, the customer risk score is obtained. The risk score is based at least in part on the customer attributes and one or more rules assessed by a customer risk assessment tool of the retail enterprise. The customer risk score is dynamic, and the risk score changes as the purchasing history, return history, and other customer account details change.

At step 520, data is analyzed from a plurality of sources, such as customer history 510, attributes from the order 512, number of customer contacts 514, and fraud and security history 516.

Customer history 510 includes sales order metrics and return metrics for both in-store and online purchases. In an example, customer history 510 may be collected over a period of six months. In another example, customer history 510 may be collected over a different period of time. Sales order metrics includes total orders, total amount spent, total purchases, and the percentage of returns to purchases. Return metrics include total number of returns, total refund amount the customer can keep, total replacement amount, total advance replacement amount, total advanced refund amount, and total refund amount.

Attributes from the order 512 include information regarding the order including the item to be returned in the return request. The order also includes item attributes, such as the item description and the item cost. Attributes of the order 512 also include the total number of items in the order, the total cost of the order, how the order was received (e.g., delivered, in-store pickup, in-store shopping).

Number of customer contacts 514 includes salesforce information such as the number of customer contacts over the lifetime of the customer account, and any recent customer contact issues. Customer contact issues may include whether or not a pervious contact resulted in a solution.

Fraud and security history 516 includes information that relates to fraud or security risk associated with the customer. Such information includes past fraudulent charges associated with the address, credit card, or email address associated with the customer and/or the customer account. Additional information includes other risk scores for pre-purchases, if the customer is a known reseller, a known fraudulent address on the customer account, and any past account takeover fraud.

At step 506, a model is trained to predict fraud risk of the customer. The model 506 receives information from data analysis 520 and the customer risk score 504 to predict the likelihood that the customer is a trustworthy customer. A trustworthy customer is a customer that will complete the return process of an inventory item, even after that customer has received a refund or a product exchange.

The customer rating and data attributes 508 are received from the model 506. The customer rating and data attribute 508 information is used to determine return options 522. Once the return options 522 are determined for customer, they are provided to the customer 524. As described above, there are a plurality of return options. In an example, only one return option is presented to the customer, while in another example, multiple return options are presented to the customer and the customer is able to select one.

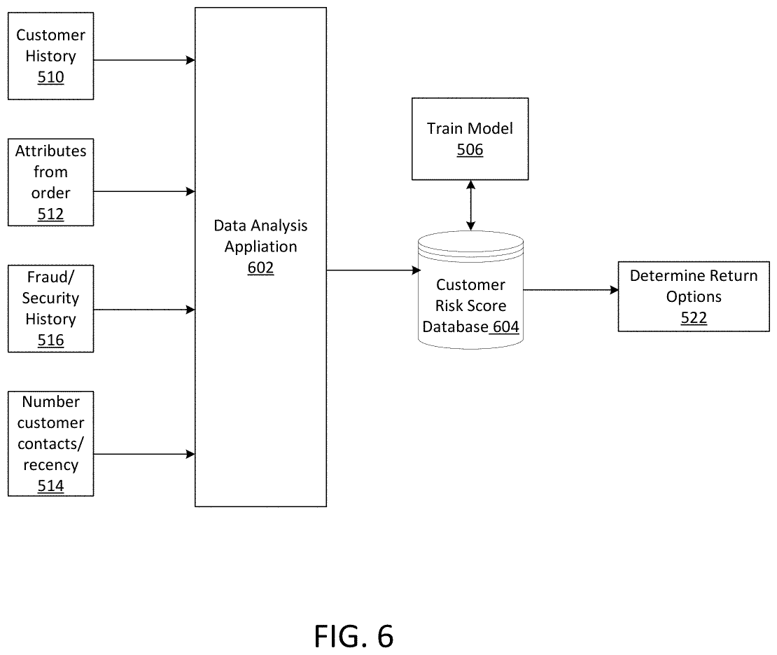

FIG. 6 illustrates an example architecture 600 for determining a customer risk score by training a model to predict potential returns abuse.

The data analysis application 602 receives information from customer history 510, attributes from the order 512, fraud and security history 516, and the number of customer contacts 514 to train a model for identification of potentially fraudulent activity with respect to a particular customer, item, or both. The model can output parameters that may be used in generation of a customer risk score. Then, the data analysis application 602 passes the predictive customer risk score that is or is not weighted to a database 604 that stores the information for each customer.

Factors accounted for by the data analysis application 602 may vary widely. These may include, for example, past fraudulent activity of the customer attempting to make a return, but are not so limited. For example, additional factors may include: a manner of initiating a return (e.g., via a mobile application or website, based on a particular channel having a greater likelihood of fraudulent returns), a time of day (e.g., in case returns of a particular item, or at a particular location, are more likely to be determined fraudulent), a pattern of purchases and returns being similar to that of a different, known-fraudulent user, a payment methodology (e.g., cash vs. credit card vs. branded credit card vs. gift card, with some having higher likelihood of fraud over others), or other methodologies.

The predicted customer data scores stored in the database 604 are used to train a model 506 for future prediction of customer risk scores. The database 604 passes the score information to determine return options 522.

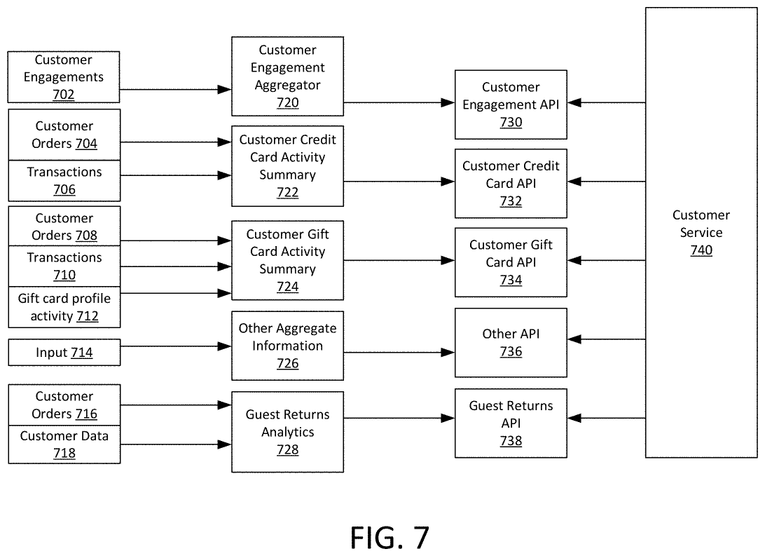

FIG. 7 illustrates an example block diagram of gathering information to create a customer profile. The method collects data at different time periods, depending on how often the inputs of the data change. Each of the sets of metrics or inputs have a specific timing requirement to ensure the data is accurate. Some data can be calculated daily and summed across all activity for the day. Other data, such as return data affecting decisions to automate returns when there is risky behavior, may need real-time updates to support obtaining the most accurate information possible. Therefore, each set of information is collected independently.

Customer engagement aggregator 720 collects customer engagement inputs 702. Customer engagement inputs 702 include information related to how often a customer contacts the retail enterprise. Information can include the frequency, the duration of each contact, the reason for each contact, and the outcome of each contact. An example customer engagement is a customer-initiated contact regarding an issue the customer had with the retailer.

Customer credit card activity summary 722 collects information from customer order information 704 and transaction information 706. Customer order information 704 includes details regarding orders the customers purchased, including item details and purchase price. Customer order information 704 can also include information related to when an order was placed, how often orders are placed, and whether or not repeat orders are placed. Transaction information 706 includes information relating to transactions associated with specific customer, including item totals and purchase totals.

Customer gift card activity summary 724 receives information from customer orders 708, transactions 710, and gift card profile activity 712. Customer order information 708 includes details regarding orders the customers purchased, including item details and purchase price. Customer order information 708 can also include information related to when an order was placed, how often orders are placed, and whether or not repeat orders are placed. Transaction information 710 includes information relating to transactions associated with specific customer, including item totals and purchase totals. Gift card profile activity 712 includes information associated with the gift card, such as the total amount, the balance, and when the card was originally purchased.

Other aggregate information 726 is gathered from inputs 714. Other inputs 714 include how engaged a customer is with the retail enterprise. For example, other inputs 714 include how often a customer is engaged with programs or services offered by the retail enterprise. Other inputs 714 may include how often a customer uses retail enterprise-issued coupon or discount.

Guest returns analytics 728 collects information from customer order 716 and customer data 718. Customer order data 716 includes details regarding orders the customer returned, and what the customer's risk score was at the time of the return. Customer data 718 is data associated with a customer profile that is provided by the customer to facilitate the customer's relationship with the retailer. The customer data 718 is information provided by the customer to complete their customer profile.

Each of the data aggregators is called by a respective API. Customer engagement aggregator 720 is called by customer engagement API 730. Customer credit card activity summary 722 is called by customer credit card API 732. Customer gift card activity summary 724 is called by customer gift card API 734. Other aggregate information 726 is called by other API 736. Guest returns analytics 728 is called by guest returns API 738.

Customer service 740 collects information from the retail enterprise's application used by customers to determine which customer's information is to be retrieved by each of the APIs.

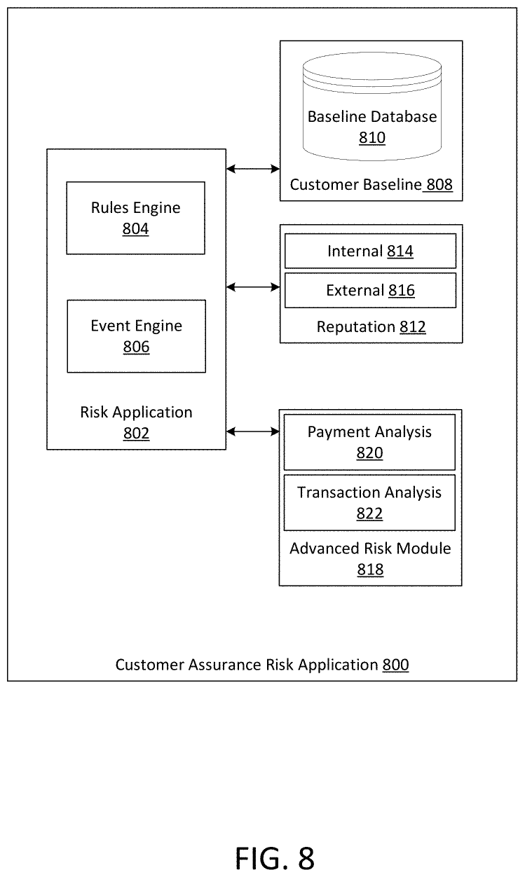

FIG. 8 illustrates a customer assurance risk application 800 for determining a customer risk score for guest assurance. The customer assurance risk application 800 can be implemented in the form of software tool executable on a computing device, such as the device shown in FIG. 11. The customer assurance risk application 800 is used during customer authentication. For example, customer authentication is used when a customer logs into their customer account page through a webpage or application of the retailer. Ensuring a customer is who they say they are is important during high risk interactions, such as placing an order or requesting a return.

The customer assurance risk application 800 determines when further verification procedures are needed for authorization. Not every customer log-in requires additional verification, and only requesting the appropriate of verification balances retailer security and customer friction.

The customer assurance risk application 800 includes a risk application 802, a customer baseline application 808, a reputation application 812, and an advanced risk module 818. The risk application 802 maintains a rules engine 804, an event engine 806, and includes an aggregate of considerations, weighted factors, and customer scoring to help determine when additional verification is needed. The rules engine 804 maintains a set of rules relating to customer account authentication, such as account age, location, velocity check, account verification, and password reset activity. If there is suspicious behavior in an account, as determined by the rules engine 804, the rules engine 804 flags that customer account to require some additional verification procedures. For example, if a customer account has multiple requests to reset the password, and the rules engine 804 determines that the number of requests exceeds a predetermined threshold, the rules engine 804 indicates that the customer account has a higher risk and may require additional verification procedures.

Additional verification procedures may include answering security questions, requiring a fingerprint, or only allowing access through a previously-authenticated computing device.

The risk application 802 also receives information from a customer baseline application 808. The customer baseline application 808 maintains a baseline database 810 that stores historical customer login information. The customer baseline application 808 utilizes the information from the database 810 to determine a baseline for each customer login's procedure. Baseline data stored in the baseline database 810 includes information such as how often the customer logs into the retail website, which computing device the customer usually uses, how long the customer remains logged in, and how often the customer enters their password wrong. The risk application 8022 uses the information received from the customer baseline application 8082 as a comparison for each login by a customer.

The risk application 802 also receives information from a reputation application 812. Reputation application 812 includes both internal reputation information 814 an external reputation information 816. Internal reputation information 814 includes past fraud history and a customer risk score. External reputation information 816 includes compromise credential information, device reputation, and IP reputation. The reputation application 812 receives the internal reputation information 814 an external reputation information 816 to generate a reputation score that is passed to the risk application 802, so the risk application 802 can determine whether or not additional verification procedures are needed.

The advanced risk module 818 also passes information to the risk application 802. The advanced risk module 818 includes payment analysis information 820 and transaction analysis information 822. Payment analysis information 820 includes a new payment type, established payment type, or gift card use to pay for orders. Transaction analysis information 822 includes part content and change order information. The information gathered by the advanced risk module 818 is passed to the risk application 802, so the risk application 802 can determine whether or not additional verification procedures are needed.

The event engine 806 triggers actions, such as killing tokens. The event engine 806 is activated when the risk application 802 determines that potential fraudulent activity is occurring on a customer's online account.

The customer assurance risk application 800 utilizes all the information gathered, as described above, to reduce login requirements for recognize customers with predicted existing behavioral patterns, requires additional verification procedures when customer assurance is questionable, and has the ability to consider multiple inputs to make an additional verification procedure determination.

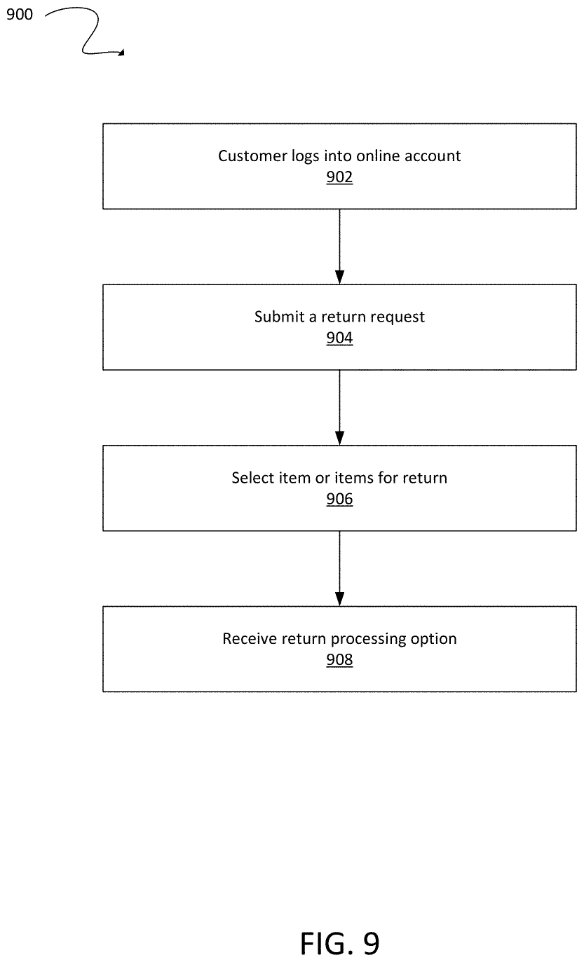

FIG. 9 illustrates a method 900 for a self-service customer return request. First, a customer logs into a customer account page 902 of a retailer website. Logging into a customer account page includes signing in with at least a username and password. In a further embodiment, a customer may be required to answer security questions, or provide two factor authentication as determined by the customer assurance risk application 800. When a customer logs into their customer account page they are able to retrieve information associated with their customer profile. This information includes, among other information, previous orders, including previously purchased items.

Then, the customer submits a return request 904. The customer is able to request to return at least one previously-purchased inventory item associated with their customer profile.

Next, the item or items that a customer desires to return are selected 906. The customer can also select the quantity of items to be returned, for example if the customer previously purchased more than one of the same items.

Finally, the customer receives at least one return processing option 908. In a first example, a customer receives only one return option. In another example a customer receives more than one return option and may select the return option they desire. Return processing options are selected from a regular refund, advance exchange, an issue refund now, and a customer can keep option. A regular refund is a refund initiated only after receiving the item from the customer. A regular exchange is an exchange order initiated only after receiving the item from the customer. Advance exchange is when the customer may or may not have already return the item but the exchange order is processed. The issue refund now is providing a refund regardless of whether the inventory item has been returned. The customer can keep is providing an exchange regardless of whether the inventory item has been returned.

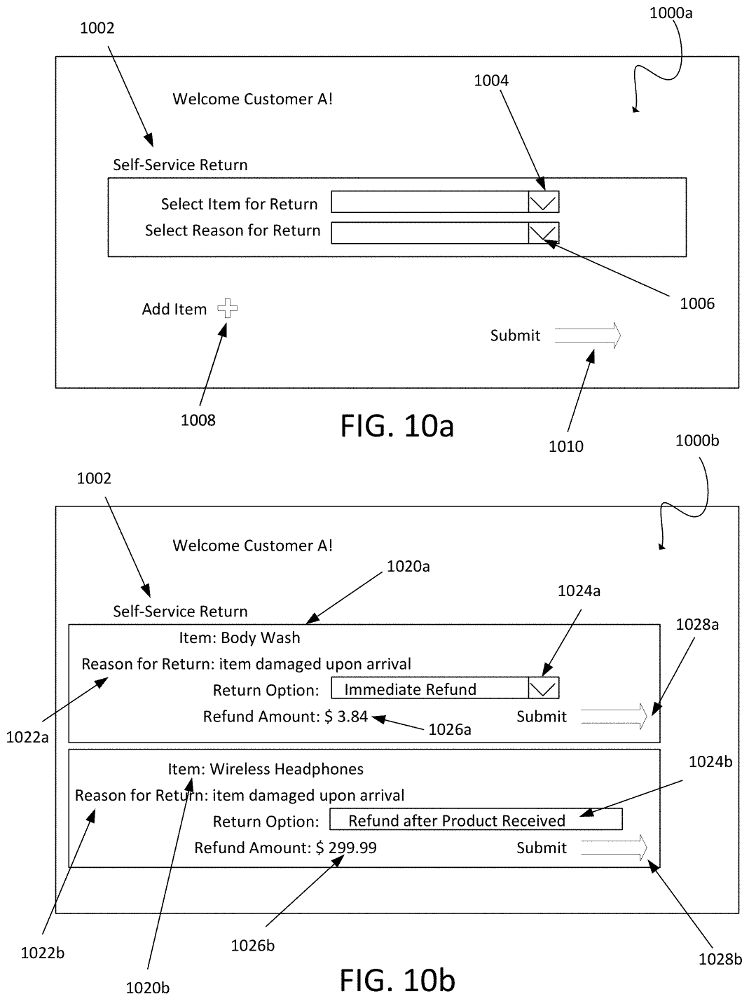

FIGS. 10a and 10b illustrate example user interfaces 1000a, 1000b of customer account page where a customer can request a return 1002.

At FIG. 10a, a customer is able to select a first item for return. The items selectable are shown as a drop-down menu 1004, and correspond to items that are been previously purchased by the customer and are associated with the customer profile. The customer is also able to select a reason for return 1006. A customer can also select to add an additional item 1008 for return. When the return request is complete the customer selects submit 1010.

After submitting the return request, the customers risk score is determined and the item attributes are used to determine which at least one return option will be presented to the customer.

FIG. 10b shows a user interface 1000b after the return processing service system 302 has determined which type(s) of return options are available for each previously purchased item. In the user interface 1000b example shown, the customer has selected to return two separate items, each of which are presented with different return options.

The first item 1020a, “body wash,” includes a reason for return 1022a, a return option 1024a, and a refund amount 1026a. The return option 1024a includes a drop down menu, which allows a customer to select which type of return option the customer wants. Once the customer has selected their desired return option, the customer can select submit 1028a to complete the return.

The second item 1020b, “wireless headphone,” includes a reason for return 1022b, a return option 1024b, and a refund amount 1026b. Only one return option 1024b is presented to the customer. If the return option is satisfactory to the customer, the customer can select submit 1028b to complete the return. It is noted that, when presented to a different customer entirely, the different customer may see different types or sets of return options, e.g., based on different characteristics of the customer or the order that included the item (e.g., time of day, method of payment, etc.).

Referring now to FIG. 11, an example block diagram of a computing system 1120 is shown that is useable to implement aspects of the clearance scheduling system 120 of FIG. 1. In the embodiment shown, the computing system 1120 includes at least one central processing unit (“CPU”) 1102, a system memory 1108, and a system bus 1132 that couples the system memory 1108 to the CPU 1102. The system memory 1108 includes a random access memory (“RAM”) 1110 and a read-only memory (“ROM”) 1112. A basic input/output system that contains the basic routines that help to transfer information between elements within the computing system 1120, such as during startup, is stored in the ROM 1112. The computing system 1120 further includes a mass storage device 1114. The mass storage device 1114 is able to store software instructions and data.

The mass storage device 1114 is connected to the CPU 1102 through a mass storage controller (not shown) connected to the system bus 1132. The mass storage device 1114 and its associated computer-readable storage media provide non-volatile, non-transitory data storage for the computing system 1120. Although the description of computer-readable storage media contained herein refers to a mass storage device, such as a hard disk or solid state disk, it should be appreciated by those skilled in the art that computer-readable data storage media can include any available tangible, physical device or article of manufacture from which the CPU 1102 can read data and/or instructions. In certain embodiments, the computer-readable storage media comprises entirely non-transitory media.

Computer-readable storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the computing system 1120.

According to various embodiments of the invention, the computing system 1120 may operate in a networked environment using logical connections to remote network devices through a network 1122, such as a wireless network, the Internet, or another type of network. The computing system 1120 may connect to the network 1122 through a network interface unit 1104 connected to the system bus 1132. It should be appreciated that the network interface unit 1104 may also be utilized to connect to other types of networks and remote computing systems. The computing system 1120 also includes an input/output controller 1106 for receiving and processing input from a number of other devices, including a touch user interface display screen, or another type of input device. Similarly, the input/output controller 1106 may provide output to a touch user interface display screen or other type of output device.

As mentioned briefly above, the mass storage device 1114 and the RAM 1110 of the computing system 1120 can store software instructions and data. The software instructions include an operating system 1118 suitable for controlling the operation of the computing system 1120. The mass storage device 1114 and/or the RAM 1110 also store software instructions, that when executed by the CPU 1102, cause the computing system 1120 to provide the functionality discussed in this document. For example, the mass storage device 1114 and/or the RAM 1110 can store software instructions that, when executed by the CPU 1102, cause the computing system 1120 to receive and analyze inventory and demand data.

Referring to FIGS. 1-11 generally, it is noted that the methods and systems have a number of advantages in terms of providing return options to different users and for different items in a customized manner. For example, different customers may be presented different sets of return options when attempting to return the same type of item based on the activity profiles of those customers or other customers having similar behavior being indicative of higher/lower risk of fraud. Still further, a same user may be automatically presented with different return options for two different types of items based on user behavior, item attributes, or other factors.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope.

1. A method of determining a return option for a customer of a retail enterprise, the method comprising:
receiving, from a customer at a customer account page of a retail web site, a request to return a previously-ordered inventory item, the request identifying the previously-ordered inventory item;
receiving customer attributes of a customer associated with an order including the previously-ordered inventory item, the customer attributes including a customer profile, historical sales order metrics, and historical return metrics from a customer attribute database;
determining a risk score for the customer, wherein the risk score is based, at least in part, on the customer attributes and one or more rules assessed by a customer risk assessment tool of the retail enterprise;
based on the risk score and the item attributes, automatically determining at least one return processing option for the customer at a returns processing service tool, wherein the at least one return processing option is presented to the customer for selection; and
presenting, to the customer, the at least one return processing option within a return user interface of the retail website.

2. The method of claim 1, wherein historical sales order metrics includes total orders, total spent, total purchases, and percentage of returns to purchases.

3. The method of claim 2, wherein automatically determining at least one return processing option for the customer excludes at least one return processing option based on the item having a value exceeding a predetermined threshold.

4. The method of claim 1, wherein historical return metrics include total returns, total refund amount, total replacement amount, total advance replacement amount, and total refund amount.

5. The method of claim 1, wherein the at least one return processing option includes a plurality of return processing options including a return option, a refund option, and a replacement option.

6. The method of claim 5, wherein the return option further includes a time at which the refund is issued.

7. The method of claim 5, wherein the refund option comprises an instant-refund option.

8. The method of claim 1, wherein a risk score exceeding a predetermined threshold represents potential fraudulent customer behavior.

9. The method of claim 1, wherein the customer attributes are obtained from at least a prior six months of data describing interactions between the customer and the retail enterprise.

10. The method of claim 1, wherein the customer profile includes past fraudulent activity, past calculated risk scores, and an identification of whether the customer is a known reseller of items purchased from the retail enterprise.

11. The method of claim 1, wherein the item attributes includes a value of the item and a frequency of fraudulent activity associated with the item.

12. The method of claim 1, further comprising accessing the customer attribute database from the customer risk assessment tool.

13. A system for determining a return option for a customer of a retail enterprise, the system comprising:
a computing system including one or more enterprise computing devices, the computing system including at least one processor and a memory subsystem including at least one memory device, the memory subsystem communicatively coupled to the at least one processor, the memory subsystem storing a customer attribute database and instructions executable to provide a customer risk assessment tool and a returns processing service tool, the instructions, when executed by the at least one processor, causing the computing system to:
receive, from a customer at a customer account page of a retail website, a request to return a previously-ordered inventory item, the request identifying the previously-ordered inventory item;
receive customer attributes of a customer associated with an order including the previously-ordered inventory item, the customer attributes including a customer profile, historical sales order metrics, and historical return metrics from a customer attribute database; determine, at the customer risk assessment tool, a risk score for the customer, wherein the risk score is based, at least in part, on the customer attributes and one or more rules managed by the customer risk assessment tool;
based on the risk score and the item attributes, automatically determine at least one return processing option for the customer at the returns processing service tool, wherein the at least one return processing option is presented to the customer for selection; and
return the determined at least one return processing option to be provided to the customer within a return user interface of the retail website.

14. The system of claim 13, wherein the customer risk assessment tool accesses the customer attribute database to determine the risk score for the customer.

15. The system of claim 13, wherein request to return a previously-ordered inventory item is received by a return processing service system, the return processing service system assessing the customer attribute database, the customer risk assessment tool, and the returns processing service tool to provide the customer with the at least one return processing option within a return user interface of the retail website.

16. The system of claim 13, wherein the customer risk score is updated in real time based on the customer profile.

17. A method of determining a return option for a customer of a retail enterprise, the method comprising:
submitting, from a first customer, a first customer log-in at a retail website;
submitting a first request, from the first customer at a customer account page of the retail website, the first request to return a first previously-ordered inventory item, the first request identifying a first previously-ordered inventory item;
submitting a second request from the first customer at a customer account page of the retail website, the second request to return a second previously-ordered inventory item, the second request identifying the second previously-ordered inventory item; and
based on the first previously-ordered inventory item and customer attributes of the first customer including a customer profile, historical sales order metrics, and historical return metrics, receiving a first set of return processing options selected from among a collection of possible return options for the first previously-ordered inventory item;
based on the second previously-ordered inventory item and customer attributes of the first customer including a customer profile, historical sales order metrics, and historical return metrics, receiving a second set of return processing options selected from among a collection of possible return options for the second previously-ordered inventory item, wherein the second set of return processing options includes at least one different return processing option as compared to the first set of return processing options.

18. The method of claim 17, further comprising:
submitting, from a second customer, a second customer log-in at a retail website, wherein the second customer is different than the first customer;
submitting a request, from the second customer at the customer account page of the retail website, a request to return a third previously-ordered inventory item;
based on the third previously-ordered inventory item and customer attributes of the second customer, receiving a return processing option selected from among a collection of possible return options for the third previously-ordered inventory item, wherein the return processing option for the second customer is different than the first return processing option for the first customer.

19. The method of claim 18, wherein the third previously-ordered inventory item is a same type of item as the first previously-ordered inventory item.

20. The method of claim 18, wherein the first customer and the second customer have a similar customer risk score.

21. The method of claim 19, wherein the first customer and the second customer have different customer risk scores.
